(19) United States
(12) Patent Application Publication
(10) Pub. No.: US 2004/0205480 A1
(43) Pub. Date: Oct. 14, 2004

(54) Auto-expiring picture internet control

(75) Inventor: David Carlton Moore, Antioch, TN (US)

Correspondence Address: FOLEY AND LARDNER, SUITE 500, 3000 K STREET NW, WASHINGTON, DC, 20007, US

(73) Assignee: G.E. INFORMATION SERVICES, INC.

(21) Appl. No.: 10/024,050

(22) Filed: Dec. 21, 2001

(51) Int. Cl. G09G 5/12

(52) U.S. Cl. 715/500.1; 715/530

(57) ABSTRACT

A method of maintaining a display is provided comprising the steps of providing an image on the display, and identifying via an identifier on the display a status of the image, the identifier being viewable only during a predetermined time criteria.

### FIELD OF THE INVENTION

The present invention relates generally to maintaining an internet WebPage, and in particular, to identifying via an auto-expiring identifier a status of an image on a WebPage.

### BACKGROUND OF THE INVENTION

Internet based communications have become commonplace in modern communications. As shown in FIG. 2, a simplified block diagram describes the basic functionality of a common internet implementation. A plurality of users 250, 260 access the internet 230 via their respective internet service provider (ISP) 240, such as AOL, AT&T Worldnet, and others. A user 250, 260 accesses via an internet browser such as Netscape, Internet Explorer, or the like, a particular WebPage (e.g., http://www.cnn.com) loaded on a web server 210 via the internet 230 by sending a request for download to the web server 210 which accesses the internet 230 via its respective ISP 220. The WebPage data is then sent via the internet 230 to the requesting user 250, 260 which loads the WebPage (e.g., html WebPage) on the user's computer.

WebPages are designed by a web developer and stored on a web server for access by internet users as previously described. New and/or altered images on a WebPage are commonly identified with a status identifier, such as a “NEW MATERIAL” symbol, “THIS SITE IS UNDER CONSTRUCTION” symbol, or the like. In conventional WebPage design techniques, a link to the status identifier is manually embedded on the WebPage using a WebPage developing program such as Microsoft FrontPage. One disadvantage of conventional techniques is that unless a WebPage designer manually removes the status identifier at some later date, the same status identifier remains on the WebPage indefinitely, even though the image is essentially no longer considered a new/altered image.

### SUMMARY OF THE INVENTION

The present invention is directed at eliminating or reducing the effects of one or more of the problems listed above, and other problems found within the prior art.

According to one aspect of the present invention, a method of maintaining a display is provided comprising the steps of providing an image on the display, and identifying via an identifier on the display a status of the image, the identifier being viewable only during a predetermined time criteria.

According to another aspect of the present invention, a status comprises one of a new image, an altered image, and a current image.

According to another aspect of the present invention, the predetermined time criteria is a maximum time limit.

According to another aspect of the present invention, the providing an image step comprises loading a WebPage including the image.

According to another aspect of the present invention, the step of identifying via an identifier on the display a status of the image comprises the step of embedding a link to the identifier.

According to another aspect of the present invention, the method further comprises a step of removing the embedded link after the predetermined time criteria.

According to another aspect of the present invention, the step of embedding a link to the identifier is performed automatically whenever the status of the image changes.

According to yet another aspect of the present invention, a method of designing a display is provided comprising the steps of generating an image to be depicted on the display, relating a time criteria to the image, and embedding a link to an identifier for identifying on the display a status of the image, wherein the embedded link expires when the time criteria is satisfied.

According to yet another aspect of the present invention, a program product comprising machine readable program code is provided for causing a machine to perform the following method steps: providing an image on a computer screen, and identifying via an identifier on the computer screen a status of the image, the identifier being viewable only during a predetermined time criteria.

According to yet another aspect of the present invention, a program product comprising machine readable program code is provided for causing a machine to perform the following method steps: generating an image to be depicted on a computer screen, relating a time criteria to the image, and embedding a link to an identifier for identifying on the computer screen a status of the image, wherein the embedded link expires when the time criteria is satisfied.

According to another aspect of the present invention, the step of relating a time criteria to the image and the step of embedding a link to an identifier are both performed automatically when an image is generated.

According to yet another aspect of the present invention, a program product for loading a WebPage comprising computer readable program code is provided for causing a machine to carry out the following method steps: generating an image to be depicted on the WebPage, and embedding a link to an identifier for identifying on the WebPage that the image is new, the embedded link automatically expiring after a pre-determined maximum time limit.

According to yet another aspect of the present invention, a WebPage maintaining device is provided comprising means for loading a WebPage on a computer, the WebPage including at least one image; means for relating a time criteria to the image; and means for identifying on the WebPage a status of the image until the time criteria is satisfied.

### BRIEF DESCRIPTION OF THE DRAWINGS

FIG. 1 is a flow chart for a method of implementing a WebPage having an auto-expiring status identifier;

FIG. 2 is a block diagram of an exemplary internet implementation for providing access to a WebPage loaded on a web server.

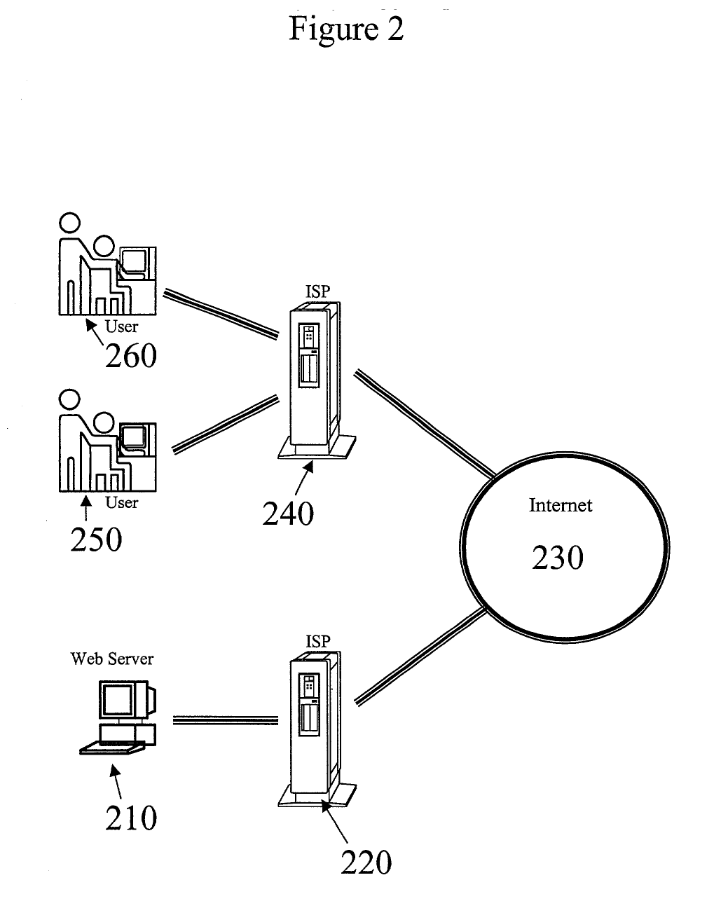

### DETAILED DESCRIPTION OF THE PREFERRED EMBODIMENTS

The embodiments of the present invention will be described by way of example but not by way of limitation in reference to a WebPage developing program, such as Microsoft FrontPage (“developer” hereafter), and an internet browser, such as Microsoft Internet Explorer (“browser” hereafter). Furthermore, the embodiments will be described in reference to providing an image to be depicted on a WebPage. It should be appreciated that the term “image” is intended to be broadly interpreted to include, but not be limited to, a picture such as a jpeg, gif, bmp, pdf, emf, wmf, pcx, or tif file, text such as a text box, a word processing file such as a doc file, or other images as would be readily apparent to one skilled in the art.

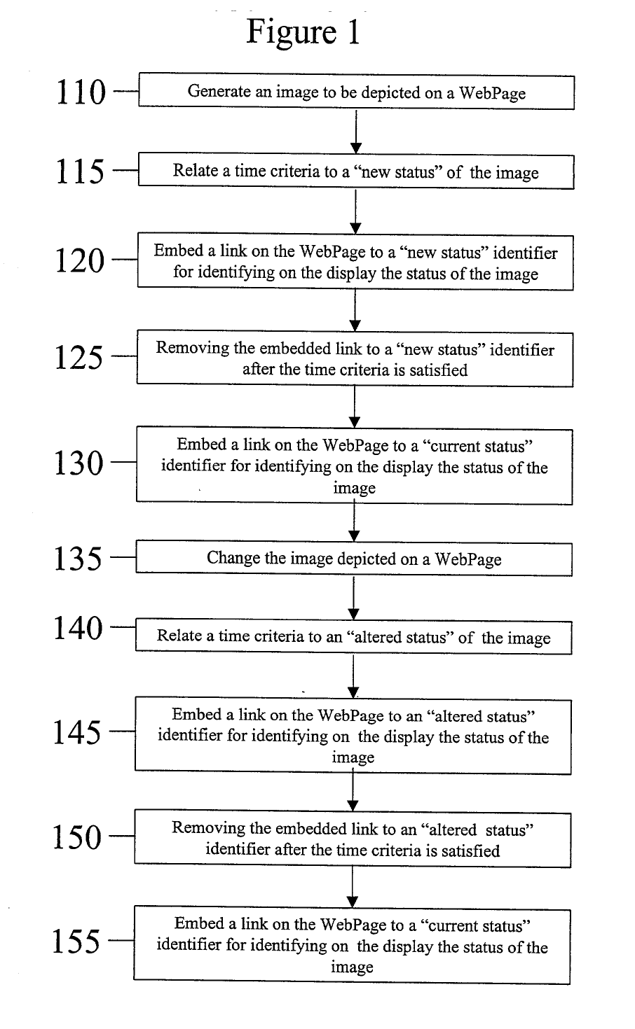

FIG. 1 shows a method of maintaining a WebPage according to a first embodiment of the present invention. In step 110, an image to be depicted on a WebPage is generated. Step 110 can be performed, for example, by importing a picture into a WebPage using a developer. A time criteria for a “new status” is related in step 115 to the image generated in step 110. A time-criteria can be related, for example, by the developer prompting the user to enter via a user interface (e.g., keyboard, mouse selectable option) a desired maximum time (e.g., one week) for the image to be considered as a new image. Alternatively, the time criteria for a “new status” can be related as a visit count for a specific user, wherein the image is considered new so long as that particular user has not viewed the image greater than a predetermined number of times. Other time criteria may also be used as would be readily apparent to one skilled in the art.

The developer then embeds a link on the WebPage to a “new status” identifier for identifying on the WebPage the “new” status of the image in step 120. Common identifiers include text such as “NEW MATERIAL” or “THIS SITE IS UNDER CONSTRUCTION” and/or pictures such as a construction sign, as well as other identifiers as would be readily apparent to one skilled in the art. One aspect of the present invention is that step 120 is preferably performed automatically whenever an image to be depicted on a WebPage is generated in step 110.

A web server hosting the WebPage continuously, sporadically, periodically, or by demand compares the related time criteria to an internal clock to determine if the time criteria has been satisfied. Alternatively, if the time criteria is a hit count, a web server hosting the WebPage or computer accessing the WebPage compares the hit count to the time criteria to determine if the time criteria has been satisfied. After the time criteria is satisfied, the embedded link to a “new status” identifier is removed in step 125. The embedded link can optionally be effectively removed, for example, by reducing the size of the image to be displayed to substantially zero, or by physically removing the code linking the identifier to the WebPage. Thus prior to step 125, a browser loading the WebPage displays the new status identifier along with the corresponding image. After step 125, a browser loading the WebPage still displays the image, but no-longer displays the new status identifier. Hence, the present invention advantageously provides for identifying via an auto-expiring identifier a status of an image on a WebPage.

Optionally, a link to a “current status” identifier can be embedded on the WebPage in step 130 to explicitly identify the image as being current (i.e., not “new status” or “archived status”). Thus, for example, an embedded link to a new status identifier, such as “This Just In” on a news WebPage (e.g., httn://www.cnn.com), may be removed in step 125, and an embedded link to a current status identifier, such as “Today's Top Stories” may then be provided for identifying a current status of the image. Hence, the present invention further provides for automatically updating the status of a WebPage when a predetermined time criteria is satisfied.

The image on the WebPage can later be changed in step 135. For example, a text image may be updated with changes such as a weather change from “sunny” to “cloudy” on a weather related WebPage (e.g., http://www.weather.com). Similar to step 115, a time criteria for an “altered status” is related in step 140 to the image changed in step 135. The web server or computer accessing the WebPage then embeds a link on the WebPage to a “new status” or “altered status” identifier for identifying on the WebPage the “altered” status of the image in step 145. After the time criteria is satisfied, the embedded link to an “altered status” identifier is removed in step 150. As similarly aforementioned with respect to step 130, optionally a “current status” link can be embedded on the WebPage in step 155.

According to the first embodiment of the present invention, an auto-expiring identifier of a status of an image on a WebPage can be provided. Thus, a user accessing the WebPage will be provided with an identifier that accurately identifies the status of an image on the WebPage. Furthermore, a WebPage developer will no longer have to manually remove status identifiers on a WebPage, thereby reducing the cost of WebPage maintenance and development. It should be appreciated that the present invention can be implemented using a variety of software and/or hardware implementations, such as java scripted, applet windows, and/or other techniques as would be readily apparent to one skilled in the art.

Exemplary java code for implementing features of the present invention is provided below. The code is provided for purposes of illustration only, and is not limiting on the scope of the invention. It should be appreciated that many different coding techniques and languages may be utilized in implementing aspects of the present invention. Other implementations, such as a picture of the day for a company intranet type application, may also require minor variations to the implementation of the invention.

```
    import.java.awt.*;
    import.javax.swing.*;
    import java.util.Date;
    import java.net.URL;
    /**
    * A class to show expiring pictures
    * This requires the following parameters in HTML document
    * ImageURL - URL of the image to load
    * ExpirationDate - date in the format 31 OCT 2001 12:00:00 GMT to
stop showing picture
    * Height = the height of the picture
    * Width = the width of the picture
    */
    public class ExpirePictureApplet extends Japplet
    {
        public void init( )
        {
        try
        {
    // This line prevents the ”Swing: checked access to system event
queue” message seen in some browsers.
    getRootPane( ).putClientProperty(”defeatSystemEventQueueCheck”,
Boolean.TRUE);
    //Test Code and example of format of parameters
    /*
    String dateAsString = ”31 OCT 2001 12:00:00 GMT”;
    URL imageURL = new URL(”file://C:/test.JPG”);
    String heightAsString = ”357”;
    String widthAsString = ”400”;
    */
    //Retrieve user parameters
        URL imageURL = new URL(getParameter(”ImageURL”));
        String dateAsString = getParameter(”ExpirationDate”);
        String heightAsString = getParameter(”Height”);
        String widthAsString = getParameter(”Width”);
    //convert parameters to data types
        Date date = new Date(dateAsString);
        Date now = new Date( );
        int height = Integer.pareseInt(heightAsString);
        int width = Integer.parseInt(widthAsString);
    //prepare for image
        getContentPane( ).setLayout(null);
        imageViewer1.setImageURL(imageURL);
        getContentPane( ).add(imageViewer1);
    //compare dates
        if (now.before(date))
        {
        setSize(width,height); //show picture at size requested by client
        imageViewer1.setSize(width,height);
        }
        else
        setSize(0,0); //don't show picture − shrink applet to where it
takes no room
        //}}
        }
        catch (Exception e)
        {
        System.err.printIn(e+e.getMessage( ));
        e.printStackTrace( );
        }
        }
        //{{DECLARE_CONTROLS
        symantec.itools.multimedia.ImageViewer imageViewer1 = new
symantec.itools.multimedia.ImageViewer( );
        //}}
        }
```

As provided above, the Java script code can be utilized to implement various features of the present invention. Many variations are possible, as would be readily apparent to one skilled in the art. As provided below, additional coding can be provided to advantageously utilize features tied to the start date if so desired.

```
    import java.awt.*;
    import javax.swing.*;
    import symantec.itools.multimedia.ImageViewer;
    import java.util.Date;
    import java.net.URL;
    /**
    * A class to show expiring pictures
    *
    * This requires the following parameters in HTML document
    * Image URL - URL of the image to load
    * StartDate - date in the format 31 OCT 2001 12:00:00 GMT to start
showing picture
    * ExpirationDate - date in the format 31 OCT 2001 12:00:00 GMT to
stop showing picture
    * Height = the height of the picture
    * Width = the width of the picture
    */
    public class ExpirePictureApplet extends Japplet
    {
        public void init( )
        {
        try
        {
    // This line prevents the ”Swing: checked access to system event
queue” message seen in some browsers.
    getRootPane( ).putClientProperty(”defeatSystemEventQueueCheck”,
Boolean.True);
    //Test Code and example of format of parameters
    /*
    String startDateAsString = ”31 OCT 2001 12:00:00 GMT”;
    String endDateAsString = ”30 NOV 2001 12:00:00 GMT”;
    URL imageURL = new URL(file:///C:/test.JPG);
    String heightAsString = ”357”;
    String widthAsString = ”400”;
    */
    //Retrieve user parameters
    URL imageURL = new URL(getParameter(”ImageURL”));
    String startDateAsString = getParameter(”StartDate”);
    String endDateAsString = getParameter(”ExpirationDate”);
    String heightAsString = getParameter(”Height”);
    String widthAsString = getParameter(”Width”);
    //convert parameters to data types
    Date endDate = new Date(endDateAsString);
    Date startDate = new Date(startDateAsString);
    Date now = new Date( );
    int height = Integer.parseInt(heightAsString);
    int width = Integer.parseInt(widthAsString);
    //prepare for image
    getContentPane( ).setLayout(null);
    imageViewer1.setImageURL(imageURL);
    getContentPane( ).add(imageViewer1);
    //compare dates
        if (now.before(endDate)&&now.after(startDate))
        {
        setSize(width,height); //show picture at size requested by client
        imageViewer1.setSize(width,height);
        }
        else
        setSize(0,0); //don't show picture − shrink applet to where it
takes no room
        //}}
        }
        catch(Exception e)
        {
        System.err.printIn(e+e.getMessage( ));
        e.printStackTrace( );
        }
        }
        //{{DECLARE_CONTROLS
        symantec.itools.multimedia.ImageViewer imageViewer1 = new
        symantec.itools.multimedia.ImageViewer( );
        //}}
        }
```

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen in generally on designer choice. It is understood that all such variations are within the scope of the invention. Likewise, software and web implementation of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined the claims appended hereto, and their equivalents.

What is claimed is:

1. A method of maintaining a display, comprising the steps of:
providing an image on said display; and
identifying via an identifier on said display a status of said image, said identifier being viewable only during a predetermined time criteria.

2. The method of claim 1, wherein a status comprises one of a new image, an altered image, and a current image.

3. The method of claim 1, wherein said predetermined time criteria is a maximum time limit.

4. The method of claim 1, wherein said providing an image step comprises loading a WebPage including said image.

5. The method of claim 1, wherein the step of identifying via an identifier on said display a status of said image comprises the step of embedding a link to said identifier.

6. The method of claim 5, further comprising the step of removing said embedded link after said predetermined time criteria.

7. The method of claim 5, wherein the step of embedding a link to said identifier is performed automatically whenever the status of said image changes.

8. A method of designing a display, comprising the steps of:
generating an image to be depicted on said display;
relating a time criteria to said image; and
embedding a link to an identifier for identifying on said display a status of said image,
wherein said embedded link expires when said time criteria is satisfied.

9. The method of claim 8, wherein a status comprises one of a new image, an altered image, and a current image.

10. The method of claim 8, wherein said display comprises a WebPage.

11. The method of claim 8, wherein said time criteria is a maximum time limit.

12. The method of claim 8, wherein the step of relating a time criteria to said image and the step of embedding a link to an identifier are both performed automatically when a new or altered image is generated.

13. A program product comprising machine readable program code for causing a machine to perform the following method steps:
providing an image on a computer screen; and
identifying via an identifier on said computer screen a status of said image, said identifier being viewable only during a predetermined time criteria.

14. The program product of claim 13, wherein a status comprises one of a new image, an altered image, and a current image.

15. The program product of claim 13, wherein said predetermined time criteria is a maximum time limit.

16. The program product of claim 13, wherein the step of providing an image on a computer screen is performed by loading a WebPage including said image.

17. The program product of claim 13, wherein the step of identifying via an identifier on said computer screen a status of said image comprises embedding a link to said identifier.

18. The computer readable disc of claim 17, further comprising automatically removing said embedded link after said predetermined time criteria.

19. A program product comprising machine readable program code for causing a machine to perform the following method steps:
generating an image to be depicted on a computer screen;
relating a time criteria to said image; and
embedding a link to an identifier for identifying on said computer screen a status of said image,
wherein said embedded link expires when said time criteria is satisfied.

20. The program product of claim 19, wherein a status comprises one of a new image, an altered image, and a current image.

21. The program product of claim 19, wherein the step of generating an image to be depicted on a computer screen is performed by generating a WebPage including said image.

22. The program product of claim 19, wherein said time criteria is a maximum time limit.

23. The program product of claim 19, wherein the step of relating a time criteria to said image and the step of embedding a link to an identifier are both performed automatically when an image is generated.

24. A program product for loading a WebPage, comprising computer readable program code for causing a machine to carry out the following method steps:
generating an image to be depicted on said WebPage; and
embedding a link to an identifier for identifying on said WebPage that said image is new, said embedded link automatically expiring after a pre-determined maximum time limit.

25. A WebPage maintaining device, comprising:
means for loading a WebPage on a computer, said WebPage including at least one image;
means for relating a time criteria to said image; and
means for identifying on said WebPage a status of said image until said time criteria is satisfied.

26. The WebPage maintaining device of claim 25, wherein said means for identifying on said WebPage a status of said image comprises: means for embedding a link to an identifier for identifying on said WebPage a status of said image, said embedded link expiring when said time criteria is satisfied.

27. The WebPage maintaining device of claim 25, wherein said time criteria is a maximum time limit.

28. The WebPage maintaining device of claim 25, wherein said time criteria is a hit count.
